(19) United States
(12) Patent Application Publication
(10) Pub. No.: US 2010/0011429 A1
(43) Pub. Date: Jan. 14, 2010

(54) Secure on line accounts (SOLA) system using cell phones and other wireless devices

(76) Inventor: Behruz Nader Daroga, Brampton (CA)

Correspondence Address: FAY SHARPE LLP, 1228 Euclid Avenue, 5th Floor, The Halle Building, Cleveland, OH, 44115, US

(21) Appl. No.: 12/442,989

(22) PCT Filed: Sep. 26, 2006
(86) PCT No.: PCT/CA06/01568

§ 371 Date: Mar. 26, 2009

(51) Int. Cl. G06F 21/22; H04L 29/06; G06F 15/16; G06F 3/00

(52) U.S. Cl. 726/7; 709/229; 715/700

(57) ABSTRACT

This invention describes a cell phone, or other wireless device (henceforth known as “device”), to transmit sound (audible and inaudible) alphanumeric code in any language, special characters or symbols or graphic or pictures or videos or any combination thereof, to an on-line account at a web server that is equipped with a compatible digital transceiver card and software driver and/or firmware for the operation, management and maintenance of this system. Upon verification of the transmitted code or sound, by the web server, access is granted. The said server then transmits a randomly selected new code of any combination of the codes or sounds stated above to the device for storage. The said transmission from the web server cannot be stored in any other device. The device has a menu item and/or numeric code for each on-line account of the user.

This invention relates to a cell phone or other wireless device (“device”) with a Secure On-Line Account system (SOLA) utilizing a digital code that is changed after each use of the system.

Most “devices” are equipped with an internet browser. Many web sites, e.g., of financial institutions and scientific bodies, provide web accounts for member logins. These OLAs are frequently accessed using the “devices”. Coventional security systems for OLAs utilize one of several methods, i.e., by provision of a User ID and password, by voice recognition, or by using biometrics systems. Passwords need to be easily remembered but should not be able to be “guessed” and should not be written down. However, these restrictions also leave the system vulnerable to hacking by unauthorized users using software or spyware at the web site or by “phishing” the OLA holder. Voice recognition systems require appreciable memory space, are slower to respond, and voices can be recorded accurately and played back to the OLA web server leaving the system vulnerable to hacking. Biometrics systems can encounter user resistance since the biometrics information can be misused if it falls into malevolent hands. Theoretically, even biometrics information can be recorded by spyware leaving the system vulnerable. Even security systems using 32 bit encryption, one of the most secure systems in use, have been hacked using software. Banking, investment and other on-line financial accounts have been hacked and their accounts depleted without knowledge of the account holder.

Clearly a need is identified for a “hacker proof” security system especially for use in systems deployed for on-line accounts (OLA) at web sites and anywhere where sensitive data and documents are stored.

The drawbacks of the present practice for security of OLAs are eliminated with the use of the said device equipped with the SOLA system. Such a device is capable of transmitting (and receiving and storing) a sound or alphanumeric code in any language, or special characters or symbols or graphic or pictures or videos or any combination thereof. The source of sound can be device generated or pre-recorded from a vast array of sources. These sources are listed in, but not limited to, the list in appendix 1. The list of pictures or videos can be similarly taken from, but not limited to the said appendix. Variables for alphanumuric in any language, special characters, symbols, or graphics are equally vast. A code comprised of any one of these would present a daunting task to any hacker. When used in combination, the system would be impossible to hack. Each OLA would require a different menu item selected from a pre-defined list and/or a numeric code. The transmitted code stored is specific for each OLA.

When setting up on-line accounts using the conventional system, the user is prompted to enter a User Identity (ID) and a password and to re-enter the password to check for accuracy and repeatability. If the host web server is equipped with the SOLA system, the user is prompted to select the conventional or SOLA system. If the SOLA system is selected, the user is asked for a ID and then prompted for a password. The user enters a numeric code or selects an item from a pre-defined list displayed on the screen on the device. The said numeric code is not the password and only serves to locate the stored code for the specific OLA. The user is not requested to reenter the password.

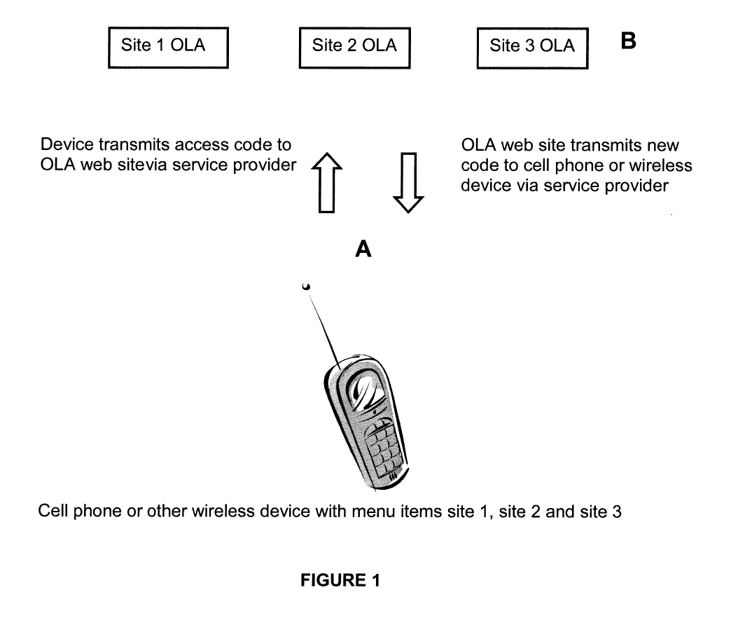

FIG. 1 illustrates the use of the system. On selecting the menu item or entering the code for the site, on first use, the device (A) with the SOLA system generates a random combination of the sounds or alphanumeric code in any language, or special characters or symbols or graphic or pictures or videos or any combination thereof. The signal is transmitted via the cell phone service provider to the web server hosting the OLA (B). The said server then transmits a random combination of the said signals via the cell phone service provider to the device. This new code is stored in ‘A’ as well as ‘B’.

On subsequent use of the SOLA system to access ‘A’ the new code is transmitted. Upon verification of the code by ‘B’ access is granted. The server then transmits a new randomly generated code for storage in ‘A’ as well as ‘B’.

This process continues for each use of the system. Therefore passwords are specific for each OLA and are changed on each use of the system and do not need to be remembered. The codes would be impossible to hack. Recording the transmitted signal would serve no purpose as this signal is changed on each use. Recording of the code by any spyware would serve no purpose for the same reason. The response time to this system would be much quicker and require less memory space than voice recognition systems. The new code transmitted by ‘B’ cannot be received and stored in any other device. Needless to say, the device ‘A’ has to be located in a secure place.

In the event, the “device” is lost or stolen, the user, as is the normal practice, calls the cell phone service provider who will place a restriction on the “device” after the user satisfactorily answers a few security questions. On acquiring a new “device” the user will need to set up the OLAs again by calling the respective sites to re-set the passwords. This can be inconvenient and is similar to losing a bunch of keys. However, if the “device” is tagged by a “War AMPS” tag for example the “device” can be returned to the user.

### APPENDIX 1

Sources and agents of sound and pictures include but not limited to:
1. Human beings and animals, birds, insects. fish, whales, dolphins.
2. In any language, music, songs, videos, themes music from films. Musical instruments and tuning forks,
3. Running water, rain water, waterfalls, tributaries, rivers lakes, melting snow and ice, piped water, treated and untreated water, icebergs, glaciers.
4. Volcanoes, hurricanes, tornadoes, gales, ordinary wind, solar wind, earthquakes, tsunami, lightning and thunder or any other sounds from nature.
5. Operating machines of any size, anywhere in any industry including ultrasound.
6. Transport vehicles of any size, powered or manual, used anywhere.
7. Objects falling to earth from sky.
8. Explosions, avalanches.
9. Elevators.
10. Sporting events and stadiums, race courses.
11. Church or religious services conducted anywhere in any religion.
12. Clock tower bells, church bells in any religion anywhere, door bells and chimes.
13. Public meetings and demonstrations.
14. Theme park, funfare and circus sounds.
15. Farms and markets.

1-14. (canceled)

15. A system for providing access authorization to an on-line account associated with a server, comprising:
a security device for transmitting a current signal upon user command once only along a communications interface to the server and for receiving a subsequent signal along the communications interface; and
security means associated with the on-line account for:
a. precluding user access to the on-line account until the security means receives a signal along the communications interface that matches the current signal; and
b. thereafter generating and transmitting along the communications interface the subsequent signal for authorizing a subsequent user access of the on-line account.

16. The system according to claim 15, wherein the security device comprises means for temporarily storing the current signal received along the communications interface until it is retransmitted back along the communications interface.

17. The system according to claim 15, wherein the security means comprises means for temporarily storing the current signal until it is successfully matched against the received signal along the communications interface.

18. The system according to claim 15, wherein the security device and the security means are preconfigured before use with a default signal as the current signal.

19. The system according to claim 18, wherein the preconfiguration comprises the security device transmitting the default signal along the communications interface in a configuration mode.

20. The system according to claim 15, wherein the communications interface is restricted to communications between the security device and the security means.

21. The system according to claim 15, wherein the security device is a cellular phone.

22. The system according to claim 15, wherein the signals passing along the communications interface are based on technology selected from a group consisting of: audible sound, inaudible sound, codes for alphanumeric characters in a language, codes for special characters, codes for symbols, codes for graphics, codes for pictures and a combination of one or more of the members of the group.

23. The system according to claim 15, wherein the signals passing along the communications interface are recorded from a source selected from a group consisting of: computer-generated material; human beings, animals, birds, insects, fish, whales, dolphins; music, songs, videos, theme music from films, musical instruments, tuning forks, running water, rain water, waterfalls, tributaries, rivers, lakes, melting snow, melting ice, piped water, treated water, untreated water, icebergs, glaciers, volcanoes, hurricanes, tornadoes, gales, ordinary wind, solar wind, earthquakes, tsunami, lightning, thunder, sounds from nature, operating machines of any size anywhere in any industry, ultrasound, transport vehicles of any size, powered or manual, used anywhere, objects falling to earth from sky, explosions, avalanches, elevators, sporting events, stadiums, race courses, church or religious services conducted anywhere in any religion, clock tower bells, church bells in any religion anywhere, door bells, chimes, public meetings, demonstrations, theme parks, funfare, circus sounds, farms and markets.

24. The system according to claim 15, wherein the current signal and/or the subsequent signal is randomly selected.

25. The system according to claim 15, wherein the security device is a handheld device.

26. A method of providing access authorization to an on-line account, comprising the acts of:
a. providing to a user a security device;
b. restricting access to the on-line account by the user until a security means associated with the on-line account receives a signal along a communications interface to the server that matches the current signal;
c. upon user input at the security device, transmitting once only the current signal along the communications interface;
d. thereafter generating at the security means a subsequent signal for authorizing a subsequent user access of the on-line account; and
e. the security means transmitting the subsequent signal to the security device along the communications interface.

27. A security device for providing access authorization to an on-line account associated with a server, adapted to transmit, upon user command, a current signal once only along a communications interface to the server and thereafter to receive a subsequent signal along the communications interface, and;
whereby security means associated with the on-line account may:
a. preclude user access to the on-line account until the security means receives a signal along the communications interface that matches the current signal; and
b. thereafter generate and transmit along the communications interface the subsequent signal for authorizing a subsequent user access of the on-line account.

28. A security means associated with an on-line account associated with a server for:
a. precluding user access to the on-line account until the security means receives a current signal along a communications interface to the server that matches a current signal; and
b. thereafter generating and transmitting along the communications interface a subsequent signal for authorizing a subsequent user access of the on-line account;
whereby a security device configured to transmit, upon user command, the current signal once only along the communications interface and thereafter to receive the subsequent signal along the communications interface may provide access authorization to the on-line account.
